(19) United States
(12) Patent Application Publication
(10) Pub. No.: US 2007/0246359 A1
(43) Pub. Date: Oct. 25, 2007

(54) Gas sensing element, gas sensor using the same and related manufacturing method

(75) Inventors: Tomio Sugiyama, Nagoya (JP); Takehito Kimata, Kariya-shi (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/713,744

(22) Filed: Mar. 5, 2007

(30) Foreign Application Priority Data
Apr. 19, 2006 (JP) 2006-115460

(51) Int. Cl. G01N 27/26; C04B 35/64

(52) U.S. Cl. 204/429; 264/618

(57) ABSTRACT

A gas sensing element and related manufacturing method are disclosed with a solid electrolyte body having one surface formed with a measuring-gas-side electrode and the other surface formed with a reference-gas-side electrode, wherein a measuring-gas-side lead portion is formed on the solid electrolyte body in connection with the measuring-gas-side electrode and a reference-gas-side lead portion is formed on the solid electrolyte body in connection with the reference-gas-side electrode. A dense protective layer is formed on the solid electrolyte body so as to cover the measuring-gas-side lead portion, and a porous protective layer is laminated on the dense protective layer so as to cover the measuring-gas-side electrode, wherein the relationship is established as QB≧0.8 QA where QB represents a porosity rate of a base end region of the measuring-gas-side lead portion in an area spaced from the base end of the dense protective layer by a distance of approximately 0.5 mm and QB represents a porosity rate of a base region of the measuring-gas-side lead portion.

### CROSS REFERENCE TO RELATED APPLICATIONS

This application is based on Japanese Patent Application No. 2006-115460, filed on Apr. 19, 2006, the content of which is hereby incorporated by reference.

### BACKGROUND OF THE INVENTION

1. Field of the Invention

The present invention relates to gas sensors for detecting a concentration of specified gas in measuring gases and, more particularly, to a gas sensing element, a gas sensor employing the same and a method of manufacturing the gas sensing element.

2. Description of the Related Art

In the related art, attempts have heretofore been made to provide gas sensing elements, composed of electrochemical elements each including a solid electrolyte body having one surface formed with a measuring-gas-side electrode and the other surface formed with a reference-gas-side electrode, which are known as oxygen sensors as disclosed in U.S. Pat. No. 4,559,126, U.S. Pat. No. 4,655,901 and U.S. Pat. No. 5,302,276.

With each of these oxygen sensors, measuring gases are brought into contact with the measuring-gas-side electrode and reference gas is brought into contact with the reference-gas-side electrode, with a voltage being applied across the measuring-gas-side electrode and the reference-gas-side electrode. This results in an electromotive force, occurring across the measuring-gas-side electrode and the reference-gas-side electrode, which is measured to detect an oxygen concentration component in exhaust gases.

With the gas sensor disclosed in U.S. Pat. No. 4,559,126, a solid electrolyte body has one surface formed with a measuring-gas-side electrode, having an area to be brought into contact with measuring gases, which is covered with a single porous protective layer. With such a structure, the gas sensor has an exhaust gas electrode lead wire that is covered with two layers, that is, the porous protective layer and a dense layer covered on the porous protective layer.

With the gas sensor disclosed in U.S. Pat. No. 4,655,901, further, a gas sensing element includes a solid electrolyte body formed with a measuring-gas-side electrode, acting as a high temperature portion, which is covered with a porous protective layer. In addition, the measuring-gas-side electrode is connected to the exhaust gas electrode lead wire, acting as a low temperature portion, which is covered with a dense protective layer.

With the gas sensor disclosed in U.S. Pat. No. 5,302,276, furthermore, a gas sensing element includes a solid electrolyte body formed with a measuring-gas-side electrode, acting as a high temperature portion and covered with a first porous protective layer, and an exhaust gas electrode lead wire, acting as a low temperature portion covered with a second porous protective layer that is lower in gas permeability than that of the first porous protective layer.

However, with the gas sensors disclosed in U.S. Pat. No. 4,559,126 and U.S. Pat. No. 5,302,276, the electrode lead wire portions, connected to the measuring-gas-side electrodes are merely covered with only the porous protective layers. The consequences of this are that the electrode lead wire portions were exposed to measuring gases. When this takes place, the electrode lead wire portions function as electrodes and characteristics of the gas sensing element increases. Such issues provide adverse affects on gas sensors of limiting electric current types operative on pumping operations.

Meanwhile, with the gas sensor disclosed in U.S. Pat. No. 4,655,901, the electrode lead wire portion, connected to the measuring-gas-side electrode, is covered with the dense protective layer. Thus, the gas sensor of such a structure has no such variation in detecting characteristic mentioned above. However, another issue arises with the occurrence of flaking of the electrode lead wire portion.

That is, during a process of manufacturing an oxygen sensor, the gas sensing element is exposed to various solutions and slurries or the like on stages of processing and inspections. Under such situations, moisture such as solution tends to penetrate the porous protective layer. In addition, the electrode layer and the electrode lead wire portion have no choice but to be porous due to limitations on characteristics such as bonding property or the like with respect to the zirconium solid electrolyte body. Moisture, penetrating the porous protective layer, comes to enter the insides of the electrode and the associated electrode lead wire portion.

Subsequently, heat treatment is carried out with a view to removing moisture and burning ceramic. During such heat treatment, moisture penetrating the electrode lead wire or the like is rapidly evaporated (gasified). As steam pressure, arising such evaporation, exceeds strength of the dense protective layer covering the electrode lead wire, the dense protective layer is caused to rupture. When this takes place, cracking occurs in both the electrode lead wire portion and the dense protective layer. Thus, there is a fear of the electrode lead wire portion breaking.

Further, the gas sensing element may be conceivably formed in a structure to place the base end portion of the dense protective layer on the electrode lead wire portion in the middle thereof to cause moisture, penetrated the electrode lead wire portion, to be released from the base end portion of the dense protective layer. However, with such a structure employed, the porosity rate of the electrode lead wire portion is minimized at a position where the base end portion of the electrode lead wire portion is located, causing a fear to occur with no route for steam to escape.

That is, after the dense protective layer has been formed so as to cover the electrode lead wire portion, the pressing operation is carried out with a view to smoothing a surface of the dense protective layer. When this takes place, if the base end portion of the dense protective layer is located on the electrode lead wire portion at the middle thereof, the base end portion of the dense protective layer is caused to sink in the electrode lead wire portion. Thus, there is a fear of the electrode lead wire portion having a decreased porosity rate.

This is due to the fact described below. That is, the dense protective layer is formed by screen-printing. During such screen-printing, the dense protective layer has a base end portion formed with a printing saddle in a localized area with a greater thickness than that of the other remaining area (see FIG. 8). During pressing operation, if pressing dies are brought into contact with the printing saddle, the printing saddle is caused to bite into the electrode lead wire portion. This causes the electrode lead wire portion to become too dense in structure in an area where the printing saddle is caused to bite, resulting in a drop in porosity rate. Therefore, the electrode lead wire portion is brought into a clogged condition in the relevant position associated with the printing saddle. This causes an escape route of moisture, penetrated the electrode lead wire portion, to be clogged. This results in a fear of the electrode lead wire portion flaking from the solid electrolyte body when moisture in the electrode lead wire portion is heated into steam to cause the electrode lead wire portion to expand.

### SUMMARY OF THE INVENTION

The present has been completed with a view to addressing the above issues and has an object to provide a gas sensing element and a gas sensor using such a gas sensing element, which can prevent a measuring-gas-side lead wire portion from flaking from a solid electrolyte body, and a related manufacturing method.

To achieve the above object, a first aspect of the present invention provides a gas sensing element comprising a solid electrolyte body having oxygen ion conductivity, a measuring-gas-side electrode formed on one surface of the solid electrolyte body, a reference-gas-side electrode formed on the other surface of the solid electrolyte body, a measuring-gas-side lead portion formed on the one surface of the solid electrolyte body in electrical connection with the measuring-gas-side electrode, and a reference-gas-side lead portion formed on the other surface of the solid electrolyte body in electrical connection with the reference-gas-side electrode. A dense protective layer is formed on the one surface of the solid electrolyte body so as to cover the measuring-gas-side lead portion, and a porous protective layer is laminated on the dense protective layer so as to cover the measuring-gas-side electrode. The measuring-gas-side lead portion includes a base end region, extending in an area away from a base end of the dense protective layer, and a base region covered with the base end of the dense protective layer. The relationship is established as QB≧0.8 QA where QB represents a porosity rate of the base end region of the measuring-gas-side lead portion in an area spaced from the base end of the dense protective layer by a distance of approximately 0.5 mm and QB represents a porosity rate of the base region of the measuring-gas-side lead portion.

With the gas sensing element of such a structure, the dense protective layer has the base end portion placed on the measuring-gas-side lead portion. During the pressing step, no localized area, that is, a so-called printing saddle portion, of the dense protective layer is pressed in a surface smoothing operation. Therefore, even if moisture penetrates the measuring-gas-side lead portion and is converted in steam at high temperatures to cause the expansion of the measuring-gas-side lead portion, this steam can be released from the base end region of the measuring-gas-side lead portion to the outside.

The measuring-gas-side lead portion has the base end region, extending from the leading edge of the electrode terminal formed on the solid electrolyte body and having a porosity rate QA, and the base region, covered with the base end of the dense protective layer in an area spaced therefrom by a distance of approximately 0.5 mm and having a porosity rate QB, with the relationship being established as QB≧0.8 QA. With such a relationship maintained, the measuring-gas-side lead portion is ensured to have the base region with pores communicating in an adequate pattern in the area spaced from and covered with the base end of the dense protective layer. Thus, moisture, penetrating the measuring-gas-side lead portion and converted to steam at high temperatures, can be effectively released from the base region of the measuring-gas-side lead portion in the presence of the pores. This efficiently prevents the measuring-gas-side lead portion from flaking from the solid electrolyte body even when exposed to thermal shocks a number of frequent times. That is, it becomes possible to avoid the base region of the measuring-gas-side lead portion from clogging at the area covered with the base end of the dense protective layer. Thus, the base region of the measuring-gas-side lead portion can maintain the pores in an adequately communicating state. This permits steam resulting from moisture entering the measuring-gas-side lead portion to efficiently escape from the base end region thereof.

This results in the capability of preventing the flaking of the measuring-gas-side lead portion resulting from moisture penetrating the measuring-gas-side lead portion.

As set forth above, the present invention makes it possible to provides a gas sensing element including a solid electrolyte body formed with a measuring-gas-side lead portion that is hard to flake from the solid electrolyte body with an increase in operating life.

A second aspect of the present invention provides a gas sensor comprising an element holder, a gas sensing element supported with the element holder for detecting a concentration of specified gas in measuring gases, an atmosphere-side cover fixedly mounted on the element holder at one end thereof so as to cover a base end portion of the gas sensing element,- and an element protection cover fixedly mounted on the element holder at the other end thereof so as to cover a detecting section of the gas sensing element. The gas sensing element comprises a solid electrolyte body having oxygen ion conductivity, a measuring-gas-side electrode formed on one surface of the solid electrolyte body, a reference-gas-side electrode formed on the other surface of the solid electrolyte body, a measuring-gas-side lead portion formed on the one surface of the solid electrolyte body in electrical connection with the measuring-gas-side electrode, a reference-gas-side lead portion formed on the other surface of the solid electrolyte body in electrical connection with the reference-gas-side electrode, a dense protective layer formed on the one surface of the solid electrolyte body so as to cover the measuring-gas-side lead portion, and a porous protective layer laminated on the dense protective layer so as to cover the measuring-gas-side electrode. The measuring-gas-side lead portion includes a base end region, extending in an area away from a base end of the dense protective layer, and a base region covered with the base end of the dense protective layer. The relationship is established as QB≧0.8 QA where QB represents a porosity rate of the base end region of the measuring-gas-side lead portion in an area spaced from the base end of the dense protective layer by a distance of approximately 0.5 mm and QB represents a porosity rate of the base region of the measuring-gas-side lead portion.

With such a structure, the gas sensor includes the gas sensing element having the dense protective layer whose base end portion is placed on the measuring-gas-side lead portion. The dense protective layer has a localized area, that is, a so-called printing saddle, with which the base region of the measuring-gas-side lead portion is covered. In surface smoothing operation executed by pressing, no localized area of the dense protective layer is put in a pressing position. This allows the base region of the measuring-gas-side lead portion to have pores distributed in a favorable communicating pattern. Therefore, even if moisture penetrates the measuring-gas-side lead portion and is converted in steam at high temperatures to cause the expansion of the measuring-gas-side lead portion, this steam can be effectively released from the base end region of the measuring-gas-side lead portion to the outside.

Further, the measuring-gas-side lead portion has the base end region, extending from the leading edge of the electrode terminal formed on the solid electrolyte body and having a porosity rate QA, and the base region, covered with the base end of the dense protective layer in an area spaced therefrom by a distance of approximately 0.5 mm and having a porosity rate QB, with the relationship being established as QB≧0.8 QA.

With such a relationship established, the measuring-gas-side lead portion is ensured to have the base region with pores communicating in an adequate pattern in the area spaced from and covered with the base end of the dense protective layer. Accordingly, moisture in the measuring-gas-side lead portion and converted to steam at high temperatures can effectively escape from the base region of the measuring-gas-side lead portion in the presence of the pores under adequately communicating states. This efficiently prevents the measuring-gas-side lead portion from flaking from the solid electrolyte body even when exposed to thermal shocks a number of frequent times. Thus, the base region of the measuring-gas-side lead portion can maintain the pores under the adequately communicating states. Therefore, steam resulting from moisture entering the measuring-gas-side lead portion can be efficiently released from the base end region thereof.

Thus, the present invention makes it possible to provides a gas sensor including a gas sensing element, provided with a solid electrolyte body formed with a measuring-gas-side lead portion, which can prevent the occurrence of flaking of the measuring-gas-side lead portion with an increase in operating life of the gas sensing element.

A third aspect of the present invention provides a method of manufacturing a gas sensing element comprising the steps of preparing a primary laminate body upon forming a measuring-gas-side electrode and a measuring-gas-side lead portion on one surface of a solid electrolyte body in electrical connection with each other, forming a reference-gas-side electrode and a reference-gas-side lead portion on one surface of the solid electrolyte body in electrical connection with each other, and forming a dense protective layer on the one surface of the solid electrolyte body so as to cover the measuring-gas-side lead portion to form the primary laminate body. The primary laminate body is smoothed on both sides thereof upon pressing the same at a pressing position spaced from a base end of the dense protective layer by a distance greater than 0.5 mm. A porous protective layer is laminated on a surface of the dense protective layer of the primary laminate body so as to cover the measuring-gas-side electrode. A duct forming layer, having a duct formed in face-to-face relationship with the reference-gas-side electrode, is laminated on the other surface of the solid electrolyte body to form a secondary laminate body. The secondary laminate body is fired to form the gas sensing element.

With such a method of manufacturing the gas sensing element, the pressing operation is conducted on both sides of the primary laminate body in surface smoothing step at the pressing position leaving the base end of the dense protective layer in a position spaced from edges of pressing dies by a distance greater than 0.5 mm. Thus, the base region of the measuring-gas-side lead portion is free from pressing operation with the pores remaining intact in an adequately communicating state.

That is, with the dense protective layer formed on the solid electrolyte body by, for instance, screen-printing, the dense protective layer has a localized trailing end portion with a larger thickness than that of the other leading portion. If such a localized trailing end is pressed with the pressing dies, the localized trailing end bites into the base region of the measuring-gas-side lead portion during pressing operation. Then, the base region of the measuring-gas-side lead portion is compacted and becomes dense in structure, causing a drop in porosity rate. When this takes place, the clogging occurs in the base region of the measuring-gas-side lead portion. This causes the measuring-gas-side lead portion from flaking from the solid electrolyte body due to frequent thermal shocks in operation of the gas sensing element incorporated in a gas sensor installed on an internal combustion engine.

However, with the method of manufacturing the gas sensing element according to the present invention, the pressing operation is conducted on both sides of the primary laminate body with the base end of the dense protective layer left in a position spaced from edges of the pressing dies by a distance greater than 0.5 mm. Thus, no base region of the measuring-gas-side lead portion is subject to pressing operation and no probability occurs for the localized trailing portion of the dense protective layer bites into the measuring-gas-side lead portion. Therefore, the base region of the measuring-gas-side lead portion can ensure the adequately communicating states of the pores. Thus, it becomes possible to avoid the occurrence of clogging in the base region of the measuring-gas-side lead portion. Therefore, moisture, entering the measuring-gas-side lead portion, can be released from the base region of the measuring-gas-side lead portion to the outside in an effective fashion. Thus, the gas sensing element, obtained by the manufacturing method according to the present invention, has increased durability with less occurrence of flaking of the measuring-gas-side lead portion even exposed to thermal shocks.

Thus, according to the present invention, it becomes possible to provide a method of manufacturing a gas sensing element that can effectively prevent the occurrence of flaking of a measuring-gas-side lead portion.

With the first to third aspects of the present invention, the gas sensing element may have an application to an oxygen sensor or the like for detecting an oxygen concentration in exhaust gases of an internal combustion engine.

Further, the gas sensing element will be described herein with reference to a structure that has a distal end (leading portion) available to be inserted to an exhaust pipe of the engine and a base portion (trailing portion) available to be fixedly mounted on a wall of the exhaust pipe.

With the first to third aspects of the present invention, the “porosity rate” of the measuring-gas-side lead portion is derived in a manner described below. That is, the “porosity rate” is obtained by dividing a total sum of surface areas of the pores, sufficiently communicating with the deepest area in a cross section of the measuring-gas-side lead portion, by a total cross sectional area of the measuring-gas-side lead portion. The total sum of the surface areas of the pores in communication with the deepest area can be obtained upon picking up an image of the cross section of the measuring-gas-side lead portion and executing analysis of the resulting image using a computer.

With the measuring-gas-side lead portion having the base end region with the porosity QA and the base region with the porosity QB with the relationship established as QB<0.8 QA, if moisture enters the measuring-gas-side lead portion and becomes steam at high temperatures, the resulting steam cannot adequately escape from the base region of the measuring-gas-side lead portion to the outside. Thus, there is a fear of the measuring-gas-side lead portion flaking from the solid electrolyte body.

Further, in the manufacturing method of the present invention, if the surface smoothing operation is carried out upon pressing the localized area of the dense protective layer at a position covering an area spaced from the base end of the dense protective layer by a distance less than 0.5 mm, the base end of the dense protective layer bites into the base region of the measuring-gas-side lead portion. This causes the clogging of the pores to take place in the base region of the measuring-gas-side lead portion. This results in a difficulty for the base region of the measuring-gas-side lead portion to release moisture to the outside, causing the measuring-gas-side lead portion to flake from the solid electrolyte body. Such an issue can be effectively addressed with the manufacturing method of the present invention as set forth above.

### BRIEF DESCRIPTION OF THE DRAWINGS

FIG. 1 is a front view showing a gas sensing element of a first embodiment according to the present invention.

FIG. 2 is a cross sectional view taken on line D-D of FIG. 1.

FIG. 3 is a cross sectional view taken on line E-E of FIG. 1.

FIG. 4 is a cross sectional view showing a primary laminate body, forming the gas sensing element shown in FIG. 1, in a large scale.

FIG. 5 is a cross sectional view showing a step of smoothing both surfaces of the primary laminate body during a manufacturing process of the gas sensing element of the first embodiment shown in FIG. 1.

FIG. 6 is a plan view showing the step of smoothing the both surfaces of the primary laminate body during the manufacturing process shown in FIG. 5.

FIG. 7 is an electron micrograph (with approximately 4000 times in magnification) showing a cross section of a measuring-gas-side lead portion of the gas sensing element of the first embodiment shown in FIG. 1.

FIG. 8 is a fragmentary cross sectional view showing the relationship between a localized area of a dense protective layer and a base region of the measuring-gas-side lead portion of the gas sensing element of the first embodiment shown in FIG. 1.

FIGS. 9A to 9D are development views showing the gas sensing element of the first embodiment shown in FIG. 1.

FIG. 10 is a cross sectional view of a gas sensor incorporating the gas sensing element of the first embodiment shown in FIG. 1.

FIG. 11 is an illustrative view showing the gas sensing element dipped in water for flaking tests to be conducted.

FIG. 12 is an illustrative view showing the gas sensing element exposed to a high temperature state in an electric furnace for flaking tests to be conducted.

FIG. 13 is a graph showing the relationship between a flaking rate of the measuring-gas-side lead portion and pressing positions of pressing dies.

### DETAILED DESCRIPTION OF THE PREFERRED EMBODIMENTS

Now, a gas sensing element of an embodiment according to the present invention and related manufacturing method are described below in detail with reference to the accompanying drawings. However, the present invention is construed not to be limited to such an embodiment described below and technical concepts of the present invention may be implemented in combination with other known technologies or the other technology having functions equivalent to such known technologies.

While various aspects of the present invention are described below with reference is to a gas sensing element, it will be appreciated that the gas sensing element implementing the present invention may be incorporated in an A/F senor, an O₂ sensor and a NOx sensor, etc.

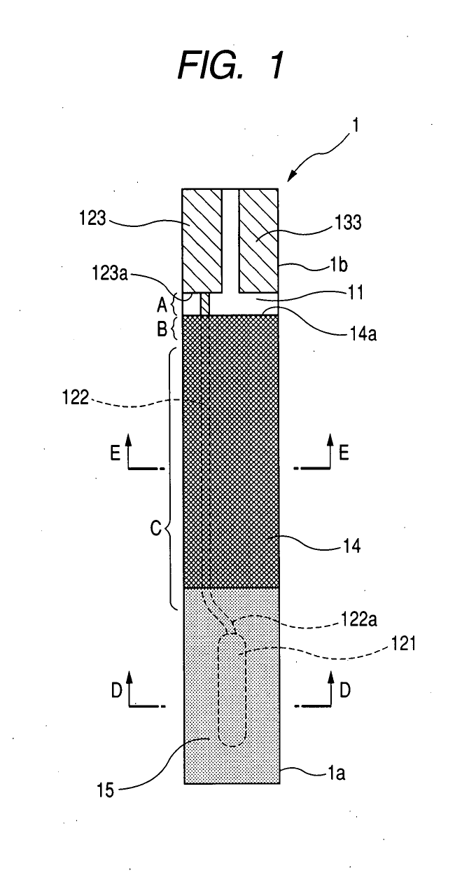

Now, a gas sensing element of a first embodiment according to the present invention and a related manufacturing method are described below in detail with reference to FIGS. 1 to 10.

As shown in FIGS. 1 to 3, the gas sensing element 1 of the present embodiment comprises an elongated plate-like solid electrolyte body 11, composed of zirconium having oxygen ion conductivity, which has one surface formed with a measuring-gas-side electrode 121 in an area near a leading end portion of the solid electrolyte body 11 and the other surface formed with a reference-gas-side electrode 131 formed at a position in opposition to the measuring-gas-side electrode 121, and a measuring-gas-side lead portion 122 formed on the solid electrolyte body 11. The measuring-gas-side lead portion 122 has a leading end 122a connected to a base end of the measuring-gas-side electrode 121.

A dense protective layer 14 is laminated on the solid electrolyte body 11 so as to cover the measuring-gas-side lead portion 122 and a porous protective layer 15 is laminated on the solid electrolyte body 11 so as to cover the measuring-gas-side electrode 121.

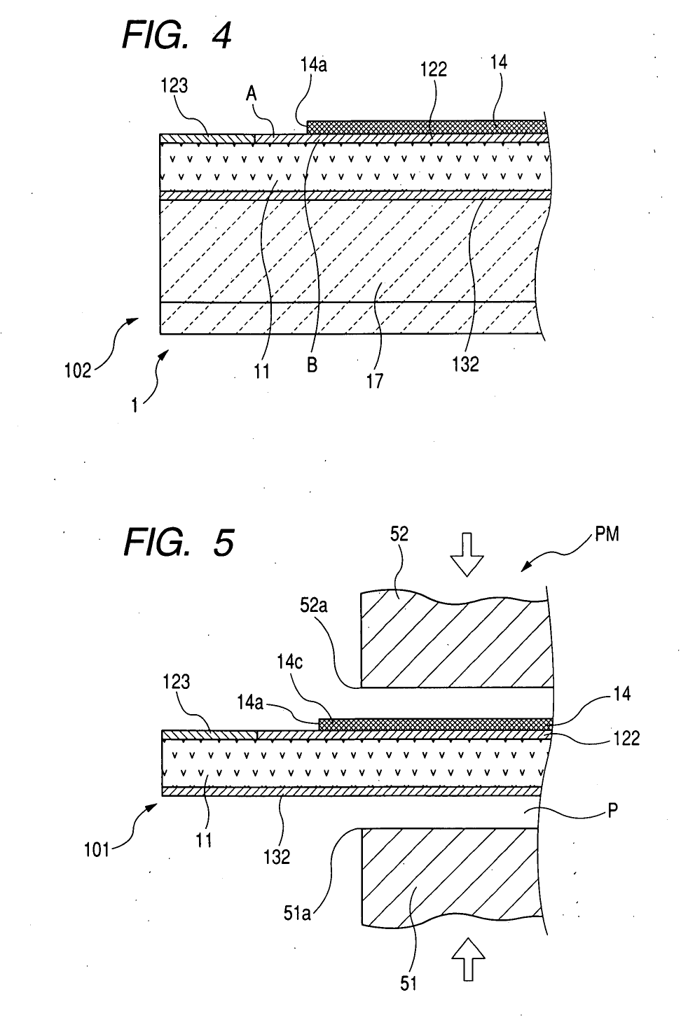

As best shown in FIGS. 1 and 4, the dense protective layer 14 has a base end 14a located in a trailing area of the solid electrolyte body 11.

The measuring-gas-side lead portion 122 has a base end region A with a porosity rate of QA and a base region B with a porosity rate QB. The base region B covers an area starting from the base end 14a of the dense protective layer 14 and ending at a position spaced from the base end 14a of the dense protective layer 14 by a distance of approximately 0.5 mm. The dense protective layer 14 is subjected to smoothing operation under a condition described to below to allow the measuring-gas-side lead portion 122 to have the base end region A with the porosity rate of QA and the base region B with the porosity rate QB established in the relationship expressed as QB≧0.8 QA.

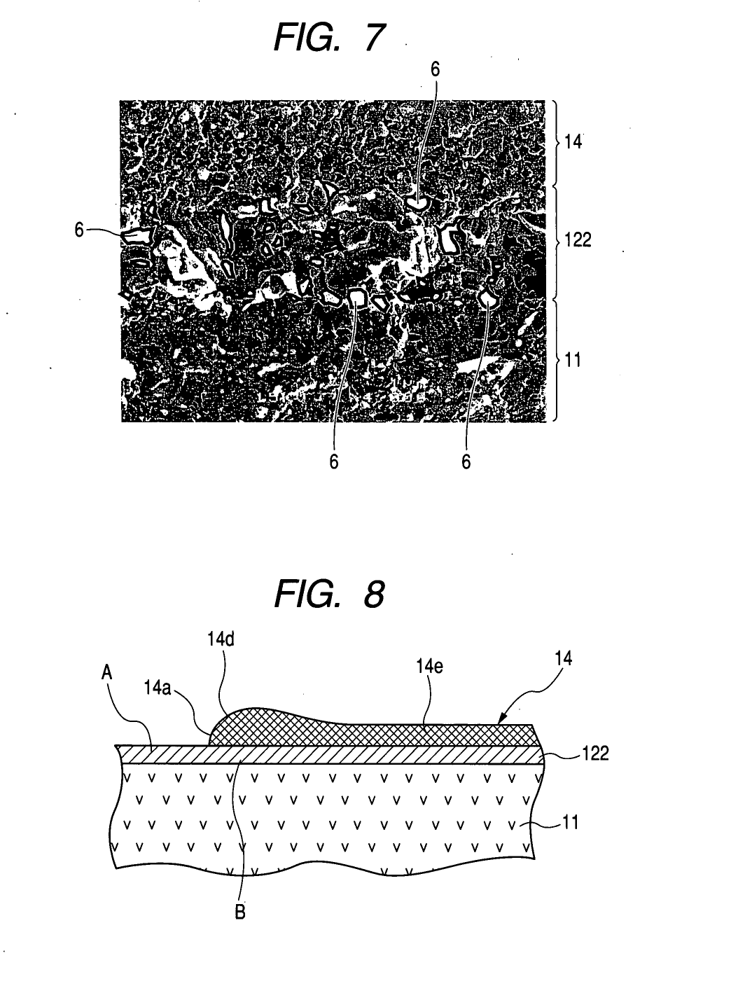

Here, the “porosity rate” is derived in such a way described below. That is, a cross section of the measuring-gas-side lead portion 122 is picked up with an electron microscope in an electron micrograph, as shown in FIG. 7, after which image analysis is conducted on the resulting image using a computer for thereby obtaining a total sum of surface areas of pores 6 sufficiently communicating with the deepest area.

Dividing the total sum of surface areas of the pores 6 communicating with the backward of the measuring-gas-side lead portion 122 by a total cross sectional area of the measuring-gas-side lead portion 122 provides a value that is regarded as the porosity ratio mentioned above.

Moreover, FIG. 7 shows an electron micrograph (with approximately 4000 times in magnification) with whitened markings added in areas judged to be the pores 6.

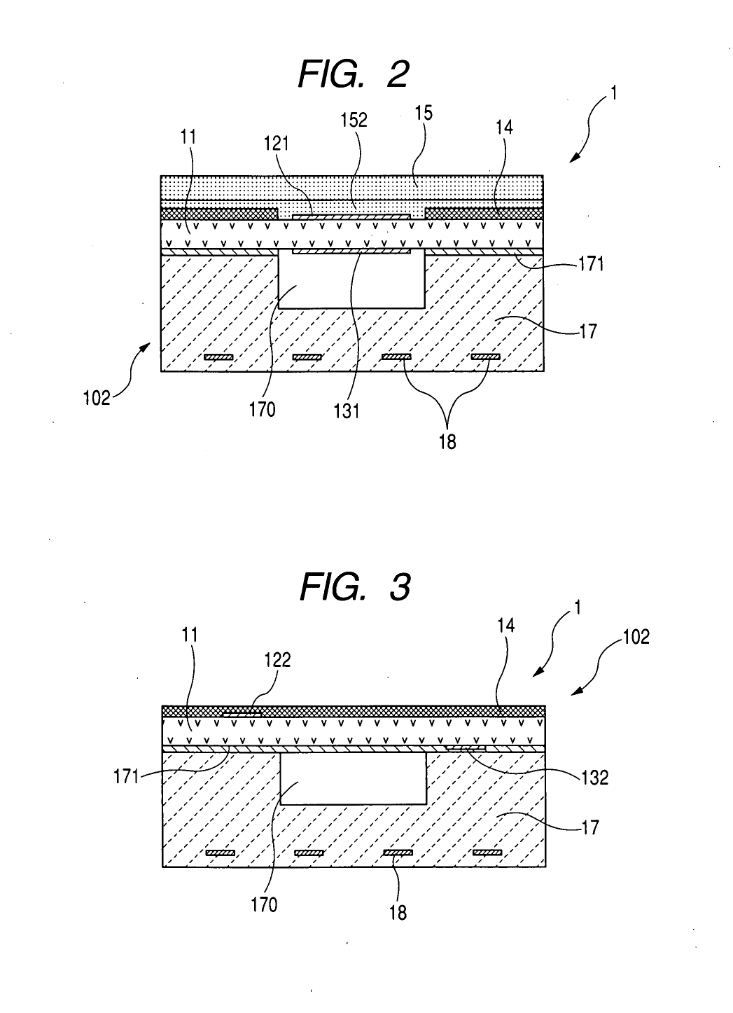

As shown in FIGS. 1 and 2, the gas sensing element 1 has the solid electrolyte body 11 having a leading end portion provided with a detecting section 1a in which the measuring-gas-side electrode 121 and the reference-gas-side electrode 131 are located on both sides of the solid electrolyte body 11 at areas in opposition to each other. As shown in FIG. 2, the detecting section 1a is formed in a structure as described below in detail.

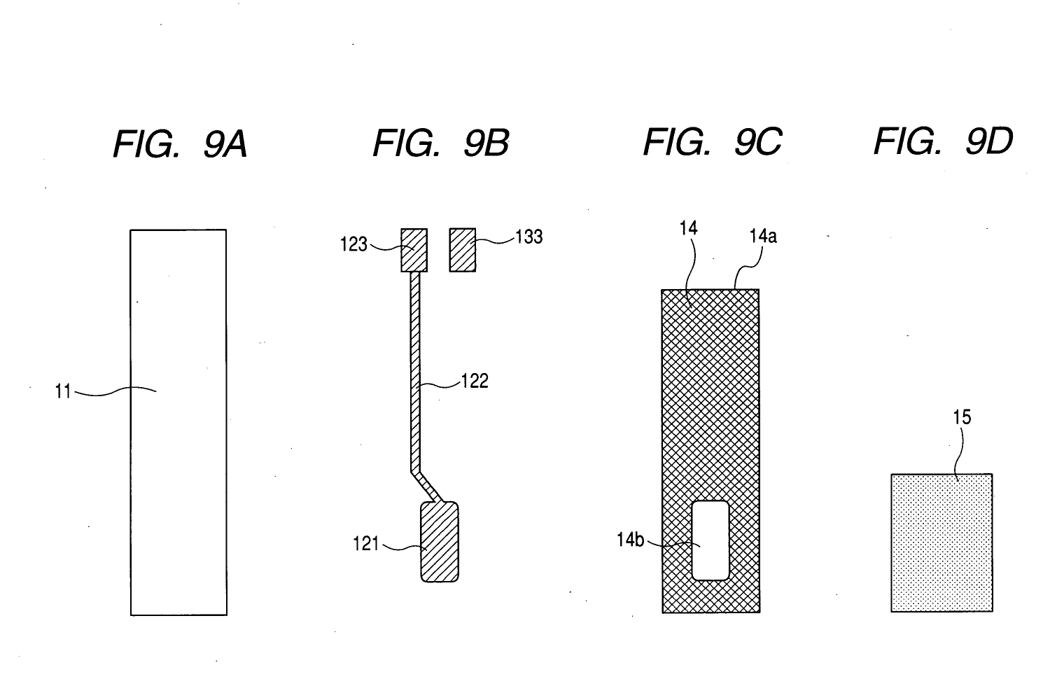

That is, as shown in FIGS. 9A and 9B, the measuring-gas-side electrode 121, the measuring-gas-side lead portion 122 and electrode terminals 123, 133 are formed on the solid electrolyte body 11 on one surface thereof. Then, the dense protective layer 14 is laminated on the solid electrolyte body 11 so as to cover the measuring-gas-side lead portion 122 with an opening portion 14b formed in a given area to allow the measuring-gas-side electrode 121 to be exposed as shown in FIG. 9C. As shown in FIGS. 2 and 9D, the porous protective layer 15 is laminated on the measuring-gas-side electrode 121 via a bonding layer 152 so as to cover the same. The bonding layer 152 has the same structure as the porous protective layer 15 and substantially forms a part of the porous protective layer 15.

Further, a duct forming layer 17 is laminated on the other surface, on which the reference-gas-side electrode 131 is formed in a position in opposition to the measuring-gas-side electrode 121, of the solid electrolyte body 11 by means of a bonding layer 171. The duct forming layer 17 has one surface, facing the other surface of the solid electrolyte body 11, which is formed with a duct 170 extending in a lengthwise direction of the duct forming layer 17 to admit reference gas (atmospheric air) to the reference-gas-side electrode 131. Thus, the reference-gas-side electrode 131, formed on the solid electrolyte body 11, is held in face-to-face relationship with the duct 170 and brought into contact with reference gas.

Furthermore, a plurality of heater elements 18 is buried in the duct forming layer 17 in a lower area thereof as shown in FIG. 2 for heating the gas sensing element 1.

Moreover, a reference-gas-side lead portion 132 is formed on the other surface of the solid electrolyte body 11 in electrical connection between a base end portion of the reference-gas-side electrode 131, formed on the connecting section 1a of the gas sensing element 1, and the electrode terminal 133 formed on the one surface of the solid electrolyte body 11 at a base end portion 1b thereof. Meanwhile, the measuring-gas-side lead portion 122 extends from the measuring-gas-side electrode 121 to the electrode terminal 123 formed on the solid electrolyte body 11 on the base end portion 1b thereof in an area adjacent to the electrode terminal 133 in parallel relation thereto.

As shown in FIGS. 1 and 4, further, the base end 14a of the dense protective layer 14 is ended at a position spaced apart from trailing ends of the electrode terminals 123, 133, thereby defining the base end region A between the electrode terminals 123, 133 and the base end 14a of the dense protective layer 14.

The solid electrolyte body 11 is made of zirconium and the dense protective layer 14, the porous protective layer 15, the bonding layers 152, 171 and the duct forming layer 17 are made of alumina.

Further, the dense protective layer 14 has no gas permeability and, in contrast, the porous protective layer 15 and the bonding layer 152 have gas permeability.

Furthermore, the measuring-gas-side electrode 121, the measuring-gas-side lead portion 122, the reference-gas-side electrode 122, the reference-gas-side lead portion 132 and the electrode terminals 123, 133 are made of cermet material composed of a mixture between metal such as platinum or the like and ceramic.

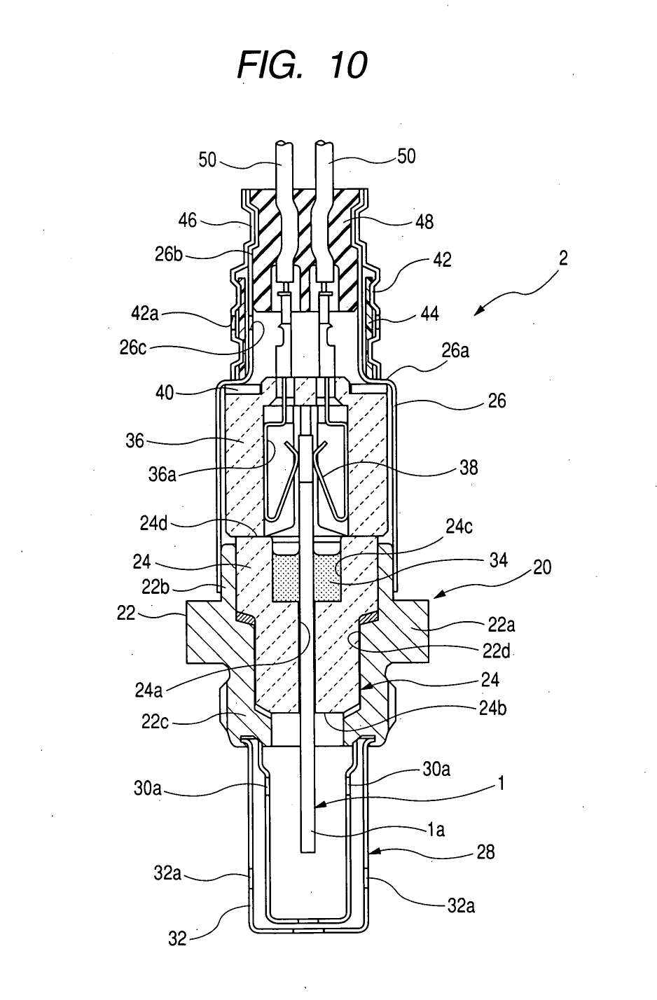

Moreover, the gas sensing element 1 is incorporated in a gas sensor 2 in a structure shown in FIG. 10.

As shown in FIG. 10, the gas sensor 2 comprises an element holder 20 composed of a housing 22 and an element-side insulator 24. The housing 22 includes a housing body 22a formed with an upper cylindrical portion 22b, acting as a base end, and a lower cylindrical portion 22c. An atmosphere-side cover 26 is fixedly supported on the upper cylindrical portion 22b of the housing 22 by welding.

The element-side insulator 24 is formed with a through-bore 24a through which the gas sensing element 1 extends and is fixedly held in place such that the porous protective layer 15 of the gas sensing element 1 has the base end extending from a distal end face 24b of the element-side insulator 24.

The element-side insulator 24 has an upper end formed with a cavity 24c filled with a sealant 34, made of glass, to provide a sealing effect in a clearance between the element-side insulator 24 and the gas sensing element 1.

An element protection cover 7 is fixedly mounted on an end face of the lower cylindrical portion 22c of the housing 22. The element protection cover 28 takes a double-layer structure that includes an inner protection cover 30, formed with a plurality of openings 30a, and an outer protection cover 32 having openings 32a. Thus, the openings 30a, 32a play roles as gas flow ports through which measuring gases are introduced to an inside of the element protection cover in contact with the detecting section 1 a of the gas sensing element 1. The housing body 22a is internally formed with a stepped bore 22d in which the element-side insulator 24 is accommodated and fixedly held in place to support the gas sensing element 1.

Further, an atmosphere-side insulator 36 is covered with the atmosphere-side cover 26 and held in contact with a base end face 24d of the element holder 20 so as to cover the base portion 1b of the gas sensing element 1. The atmosphere-side insulator 36 is internally formed with a cavity 36a accommodating metallic terminals held in electrical contact with the electrodes terminals 123, 133 (see FIG. 1) of the gas sensing element 1.

As shown in FIG. 10, the gas sensor 2 further includes a ring-like pressing member 40 is interposed between an annular shoulder 26a of the atmosphere-side cover 26 and the atmosphere-side insulator 36 for pressing the atmosphere-side insulator 36 against the element side insulator 24.

The atmosphere-side cover 26 has a base end section 26b, extending upward from an inner peripheral area of the annular flange 26a, which has a plurality of ventilation openings 26c formed at circumferentially spaced positions. The base end section 26b of the atmosphere-side cover 26 carries thereon an outer cover 42 formed with a plurality of ventilation openings 42a at circumferentially spaced positions in radial alignment with the ventilation openings 26c formed on the base end section 26b of the atmosphere-side cover 26 to introduce atmospheric air into the cavity 36a of the atmosphere aide insulator 36. Atmospheric air passes through the duct 170 (see FIG. 2) to be brought into contact with the reference-gas-side electrode 131 (see FIG. 2).

A ventilation filer 44 is interposed between the base end section 26b of the atmosphere-side cover 26 and the outer cover 42 in a position to provide a waterproof function between the ventilation openings 42a of the outer cover 42 and the ventilation openings 26c of the base end section 26b of the atmosphere-side cover 26 while admitting atmospheric air to an inside of the atmosphere-side cover 26.

As shown in FIG. 10, furthermore, the base end section 26b of the atmosphere-side cover 26 and the outer cover 16 are coupled to each other at a caulked portion 46 with which a rubber bush 48 is fixedly supported. With such a configuration, the rubber bush 48 allows the base end of the gas sensor 2 to have a waterproof function. The rubber bush 48 internally supports external lead portions 50, which are electrically connected to the electrode terminals of the gas sensing element I via the metallic terminals 38 accommodated in the atmosphere-side insulator 36.

Now, a method of manufacturing a gas sensing element 1 is described below in detail.

The manufacturing method comprises a step of forming a primary laminate body, a step of smoothing the primary laminate body, a step of forming a secondary laminate body, and a sintering step.

In carrying out the step of forming the primary laminate body, the measuring-gas-side electrode 121 and the measuring-gas-side lead portion 122 are formed on one surface of the solid electrolyte body 11, whose other surface is formed with the reference-gas-side electrode 131 and the reference-gas-side lead portion 132 are formed. Then, in next step, the dense protective layer 14 is placed on the solid electrolyte body 11 in a way to cover the measuring-gas-side lead portion 122. This allows a primary laminate body 101, shown in FIG. 5, to be obtained.

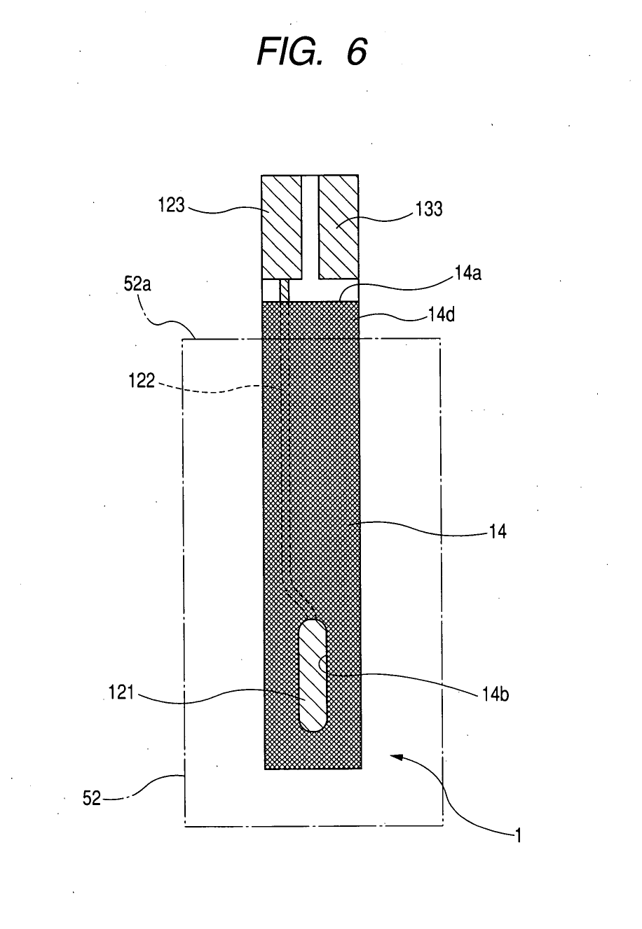

Next, in smoothing step, the primary laminate body 101 is set in a pressing space P between an upper die 52 and a lower die 51 with a marginal portion 14c, corresponding to the base region B, of the dense protective layer 14 left free from the pressing space P in a distance greater than 0.5 mm from the base end 14a of the dense protective layer 14. Then, the primary laminate body 101 is pressed on both sides thereof with the upper and lower dies 52, 51, thereby causing the both surfaces of the primary laminate body 101 to be smoothed as shown in FIGS. 5 and 6.

In subsequent secondary laminate body forming step, the porous protective layer 15 is laminated on a surface of the dense protective layer 14 of the primary laminate body 101 so as to cover the measuring-gas-side electrode 121 as shown in FIGS. 1 and 2. In consecutive step, the duct forming layer 17 is stacked on the other surface of the solid electrolyte body 11, on which the reference-gas-side electrode 131 is formed, which provides the duct 170 for introducing reference gas to the reference-gas-side electrode 131. This allows a secondary laminate body 102 to be obtained as shown in FIGS. 2 to 4.

Then, in firing step, the secondary laminate body 102 is fired, thereby obtaining the gas sensing element 1 with a structure shown in FIG. 1.

A more concrete example of the manufacturing method is described below more in detail.

First, in the primary laminate forming step, a zirconium sheet with a thickness of 250 μm is prepared as the solid electrolyte body 11. The zirconium sheet is formed s with a through-hole, which is then filled with platinum (Pt) paste. Platinum (Pt) paste is made of platinum powder, zirconium powder and organic binder or the like.

Next, the measuring-gas-side electrode 121, the measuring-gas-side lead portion 122 and the electrode terminals 123, 133 are printed on the one surface of the solid electrolyte body 11 using platinum paste. Then, the reference-gas-side electrode 131 and the reference-gas-side lead portion 132 are printed on the other surface of the solid electrolyte body 11 using platinum paste. With such a structure, the reference-gas-side lead portion 132 and the electrode terminal 133 are electrically connected to each other by means of the through-hole filled with platinum material.

The measuring-gas-side lead portion 122 and the reference-gas-side lead portion 132 have widths smaller than those of the measuring-gas-side electrode 121, the reference-gas-side electrode 131 and the electrode terminals 123, 133.

Then, ceramic paste is printed so as to cover the measuring-gas-side lead portion 122, which is consequently covered with the dense protective layer 14. Ceramic paste is made of alumina powder and organic binder or the like. With the above steps conducted, the primary laminate body 101 is obtained.

In smoothing step, as sown in FIGS. 5 and 6, the primary laminate body 101 is pressed on both sides thereof with the upper and lower dies 52, 51. During such smoothing step, the pressing operation is conducted under a condition where base ends 52a, 51a of the upper and lower dies 52, 51 are spaced from the distal end 14a of the dense protective layer 14 by a distance greater than 0.5 mm.

Then, in secondary laminate body forming step, bonding paste, containing ceramic powder and having bonding capability at normal temperatures, is printed on smooth surfaces of the primary laminate body 101 obtained in smoothing step, thereby forming the bonding layers 152, 171. Subsequently, the porous protective layer 15, acting as an electrode protective layer, and the duct forming layer 17, buried with the heater element 18, are laminated on the primary laminate body 101 by means of the bonding layers 152, 171 as shown in FIGS. 2 to 4.

Thereafter, the secondary laminate body 102 is fired, thereby obtaining the gas sensing element 1.

The gas sensing element 1 of the present embodiment has advantages effects listed below.

With the gas sensing element l, the dense protective layer 14 has the base end 14a placed on the base region B of the measuring-gas-side lead portion 122. With such a structure, even if moisture penetrates the measuring-gas-side lead portion 122 and develops into steam in an expanded state, such steam can be released from the base region B of the measuring-gas-side lead portion 122 to the outside in the presence of the pores 6 that are not clogged in structure.

Further, the measuring-gas-side lead portion 122 has the base end region A with the porosity rate QA, formed in the area defined between the terminal electrode 123 and the base end 14a of the dense protective layer 14, and the base region B with the porosity rate QB, formed in another area starting from the base end region A and ending at an edge spaced from the base end 14a of the dense protective layer 14 by the distance greater than 0.5 mm. The porosity rates QA and QB are set to satisfy the relationship as expressed as QB≧0.8 QA. With such a relationship, the pores 6 can be adequately ensured in communicating states in the measuring-gas-side lead portion 122 at a position around the base end 141a of the dense protective layer 14, enabling steam to be efficiently released from the base region B of the measuring-gas-side lead portion 122. That is, with such a relationship, no clogging takes place in the pores 6 in the measuring-gas-side lead portion 122 at the area close proximity to the base end 141a of the dense protective layer 14. Therefore, steam resulting from moisture penetrating the measuring-gas-side lead portion 122 can be adequately released from the base end 14a of the dense protective layer 14.

This results in a capability of preventing the measuring-gas-side lead portion 122 from flaking from the solid electrolyte body 11 due to moisture penetrating the measuring-gas-side lead portion 122.

Further, in performing smoothing step on a stage of manufacturing the gas sensing element 1, the primary laminate body 101 is pressed on both sides with the upper and lower dies 52, 51 in areas spaced from the base end 14a of the dense protective layer 14 by a distance greater than 0.5 mm. This makes it possible to allow a localized area 14d of the dense protective layer 14 in the vicinity of the base end 14a thereof to prevent the resulting measuring-gas-side lead portion 122 from being compacted to be too dense in structure.

That is, as shown in FIG. 8, the dense protective layer 14 is liable to be formed with the localized area 14d with an increased thickness at a position near the base end 14a when formed with, for instance, screen-printing. During pressing operation, if such a localized area 14d bites into an intermediate portion 14e, the intermediate portion 14e becomes too dense in structure. This results in a drop in porosity rate, causing a fear of the clogging taking place in the pores 6 of the measuring-gas-side lead portion 122.

With the manufacturing method of the present embodiment, the primary laminate body 101 is pressed on both sides at areas spaced from the base end 14a of the dense protective layer 14 by a distance greater than 0.5 mm during smoothing step. Therefore, no probability takes place for the localized area 14d of the dense protective layer 14 to bite into the measuring-gas-side lead portion 122. Therefore, the localized are 14d of the dense protective layer 14 has the pores 6 remaining intact in adequately communicating states. This results in a capability of preventing the pores 6 of the measuring-gas-side lead portion 122 from clogging. Thus, even if moisture penetrates the measuring-gas-side lead portion 122, such moisture can be released from the base end 14a of the dense protective layer 14. This makes it possible to efficiently prevent the measuring-gas-side lead portion 122 from flaking from the solid electrolyte body 11.

With the gas sensing element 1 and related manufacturing method set forth above, it becomes possible to provide a gas sensor and a related manufacturing method that can prevent the occurrence of flaking of a measuring-gas-side lead portion.

(First Flaking Test)

Two hundred gas sensing elements 1 were prepared for each of test pieces 1 to 10 formed with measuring-gas-side lead portions 122 having base end regions A and base regions B in various porosity rates, respectively. Tests have been conducted on the resulting gas sensing elements 1 to check flaking incidence rates of the measuring-gas-side lead portions 122.

For flaking tests, it is supposed that: a porosity rate of the base end region A of the measuring-gas-side lead portions 122, covering an area between a leading edge 123a of the electrode terminal 123 and the base end 14a of the dense protective layer 14, is QA; a porosity rate of the base region B of the measuring-gas-side lead portions 122, covering another area spaced from the base end region A (the base end 14a of the dense protective layer 14) by a distance of 0.5 mm is QB; and a porosity rate of a leading region C of the measuring-gas-side lead portions 122 is QC (see FIG. 1).

In smoothing steps of primary laminate bodies 101, pressing positions of the upper and lower dies 52, 51 were altered upon setting the base end portions 52a, 51a of the upper and lower dies 52, 51 to various positions with respect to the base end 14a of the dense protective layers 14 to vary the porosity rates of the various regions of the measuring-gas-side lead portions 122, with the results on porosity rates being indicated on Table 1.

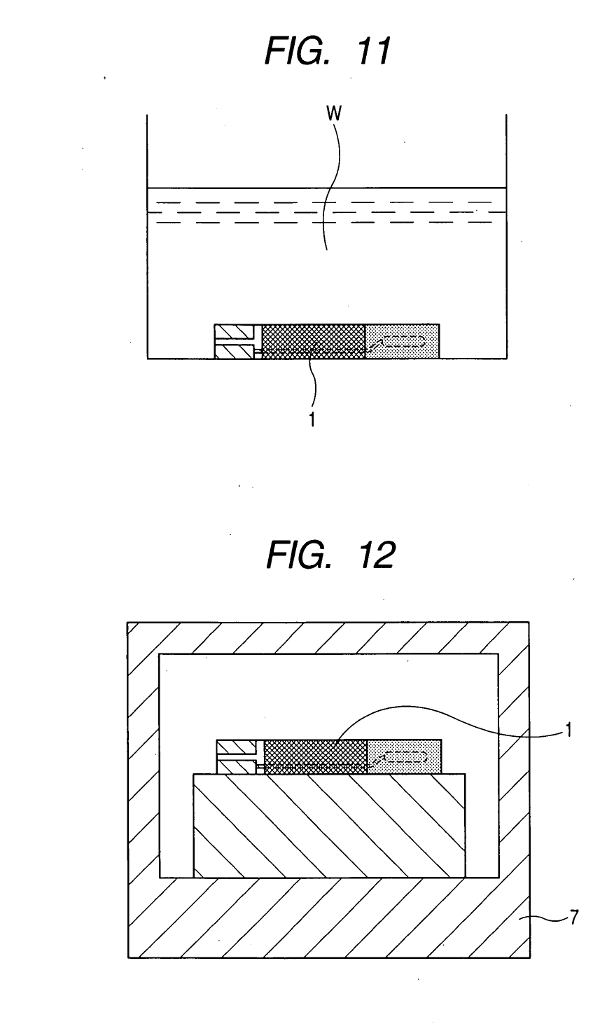

Flaking tests were conducted on these test pieces. During tests, pretreatments were conducted on the test pieces as shown in FIG. 11.

That is, the gas sensing elements 1, playing roles as the test pieces, were left in water W for 24 hours. Thereafter, the gas sensing elements 1 were placed in an electric furnace 7, which were preliminarily heated up to 500° C., and left for 15 minutes. Subsequently, the gas sensing elements 1 were taken out of the electric furnace 7 and left in the atmosphere to allow the gas sensing elements 1 to be cooled to room temperatures. Then, the gas sensing elements 1 were observed to find whether or not the flaking took place in the measuring-gas-side lead portions 122 associated with the dense protective layers 14 using a magnifying glass with ten times in magnification. The observed results are indicated in Table 1 listed below.

TABLE 1

| | Porosity Rates | | | Flaking | Flaking |
|---|---|---|---|---|---|
| Test Pieces | QA | QB | QC | Incidence | Rates (%) |
| 1 | 15 | 15 | 15 | 0/200 | 0 |
| 2 | 15 | 12 | 15 | 0/200 | 0 |
| 3 | 15 | 9 | 15 | 5/200 | 2.5 |
| 4 | 15 | 15 | 12 | 0/200 | 0 |
| 5 | 15 | 12 | 12 | 0/200 | 0 |
| 6 | 15 | 9 | 12 | 4/200 | 2 |
| 7 | 15 | 15 | 9 | 1/200 | 0.5 |
| 8 | 15 | 12 | 9 | 1/200 | 0.5 |
| 9 | 15 | 9 | 9 | 6/200 | 3 |
| 10 | 12 | 12 | 12 | 0/200 | 0 |

As will be understood from Table 1, test pieces 3, 6, 7, 8, 9 were observed with the occurrence of flaking and no flaking was observed in other test pieces 1, 2, 5 and 10. Form these facts, it is turned out that forming the measuring-gas-side lead portions 122 so as to allow the porosity rates QA and QB to satisfy the relationship QB≧0.8 QA enables the measuring-gas-side lead portions 122 to be prevented from flaking from the solid electrolyte bodies of the test pieces.

(Second Flaking Test)

Second flaking tests were carried out on the test pieces to find the relationship. between the pressing positions in smoothing step of the manufacturing method and the flaking incidence rates of the measuring-gas-side lead portions 122.

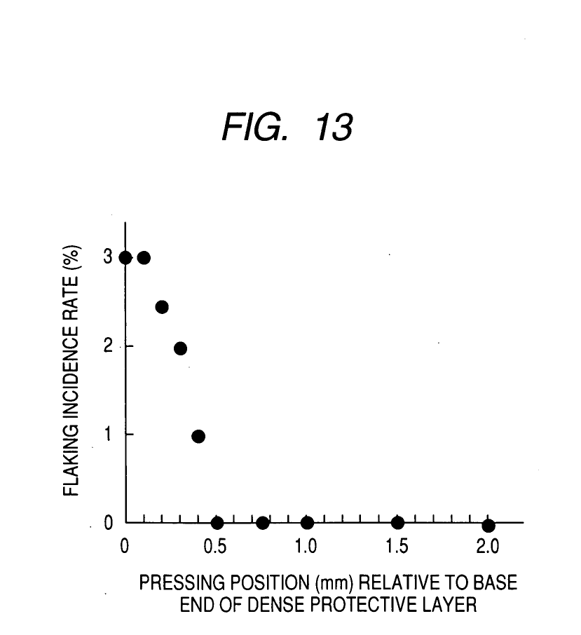

In smoothing step of the manufacturing method, the test pieces were pressed using the upper and lower press dies 52, 51 (see FIGS. 5 and 6) whose base ends 52a, 51a were displaced in respective displacement values with a reference on the base ends 14a of the dense protective layers 14 of the test pieces (on a stage of primary laminate bodies) to press the measuring-gas-side lead portions 122 at different pressing positions. Upon completing the pressing operations on the test pieces, the test pieces were observed to find whether or not the flaking occurred in the test pieces. The observation results are indicated in FIG. 13 wherein a flaking incidence rate (%), representing the occurrence of flaking taking place in the measuring-gas-side lead portions 122, is plotted on the ordinate axis and a displacement position (mm) of the pressing die (at the base ends 52a, 51a of the upper and lower pressing dies 52, 52) is plotted on the abscissa axis with the relationships being plotted with symbols “”.

Here, the term “flaking incidence rate” refers to a rate of the number of samples, which undergo the flaking of the measuring-gas-side lead portions 122, among the two hundred test pieces.

It will be understood from FIG. 13 that the flaking of the measuring-gas-side lead portions 122 occurred in the test pieces with the primary laminate bodies 101 pressed under a condition where the displacement values of the base ends 52a, 51a of the pressing dies 52, 51 were set to be less than 0.5 mm from the base end 14a of the dense protective layer 14 of each of the test pieces whereas the flaking incidences of the measuring-gas-side lead portions 122 were zeroed when the primary laminate bodies were pressed with the base ends 52a, 51a of the pressing dies 52, 51 displaced in values greater than 0.5 mm. Further, upon micro-observation on the samples encountered with the flaking, the dense protective layers 14 were found to have localized areas 14d (see FIG. 8) in the form of so-called printing saddles. Each of the localized areas 14d begun from the base end 14a of the dense protective layer 14 and ended at a position spaced therefrom by a distance of approximately 0.4mm and had raised portions with increased thickness. Each of the localized areas 14d covered the base region B (see FIGS. 1 and 8) of each measuring-gas-side lead portion 122. Thus, it can be considered that pressing the primary laminate bodies 101 at the pressing position excluding such localized areas 14d (see FIG. 8) enables the measuring-gas-side lead portions 122 to be avoided from having locally dense structures whereby the flaking of the measuring-gas-side lead portions 122 can be efficiently prevented. Accordingly, it is conceived that the test results, reflected on the relationship between the pressing position of the pressing machine PM and the flaking incidence rate, match the logic set forth above.

While the specific embodiment of the present invention has been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

Although the present invention has been described with reference to the various embodiments directed to the gas sensing elements formed in flat type structures, it will be appreciated that the particular arrangements disclosed are meat to be illustrative only and not limiting to the scope of the present invention. That is, the present invention can be implemented in other specific forms. For instance, the solid electrolyte body may be formed in a cylindrical structure. With such a structure, a porous protective layer and a dense protective layer may be formed on circumferential peripheries of the cylindrical structure to achieve the same function as that of the gas sensing element 1 shown in FIG. 1.

What is claimed is:

1. A gas sensing element comprising:
a solid electrolyte body having oxygen ion conductivity;
a measuring-gas-side electrode formed on one surface of the solid electrolyte body;
a reference-gas-side electrode formed on the other surface of the solid electrolyte body;
a measuring-gas-side lead portion formed on the one surface of the solid electrolyte body in electrical connection with the measuring-gas-side electrode;
a reference-gas-side lead portion formed on the other surface of the solid electrolyte body in electrical connection with the reference-gas-side electrode;
a dense protective layer formed on the one surface of the solid electrolyte body so as to cover the measuring-gas-side lead portion; and
a porous protective layer laminated on the dense protective layer so as to cover the measuring-gas-side electrode;
wherein the measuring-gas-side lead portion includes a base end region, extending in an area away from a base end of the dense protective layer, and a base region covered with the base end of the dense protective layer; and
wherein the relationship is established as QB≧0.8 QA where QB represents a porosity rate of the base end region of the measuring-gas-side lead portion in an area spaced from the base end of the dense protective layer by a distance of approximately 0.5 mm and QB represents a porosity rate of the base region of the measuring-gas-side lead portion.

2. The gas sensing element according to claim 1, further comprising:
first and second electrode terminals formed on the solid electrolyte body in electrical connection with the measuring-gas-side lead portion and the reference-gas-side lead portion, respectively.

3. The gas sensing element according to claim 1, further comprising:
a bonding layer interposed between the porous protective layer and the measuring-gas-side electrode.

4. The gas sensing element according to claim 1, further comprising:
a bonding layer interposed between the porous protective layer and the dense protective layer.

5. The gas sensing element according to claim 1, further comprising:
a duct forming layer laminated on the other surface of the solid electrolyte body and having a duct formed in a face-to-face relationship with the reference-gas-side electrode.

6. The gas sensing element according to claim 1, wherein:
the base end region of the measuring-gas-side lead portion is covered with a localized area of the dense protective layer in a position close proximity to the base end of the dense protective layer; and
wherein the dense protective layer has a smoothed surface in an area except for the localized area to allow the base end region and the base region of the measuring-gas-side lead portion to have given porosity rates, respectively.

7. A gas sensor comprising:
an element holder;
a gas sensing element supported with the element holder for detecting a concentration of specified gas in measuring gases;
an atmosphere-side cover fixedly mounted on the element holder at one end thereof so as to cover a base end portion of the gas sensing element; and
an element protection cover fixedly mounted on the element holder at the other end thereof so as to cover a detecting section of the gas sensing element;
wherein the gas sensing element comprises:
a solid electrolyte body having oxygen ion conductivity;
a measuring-gas-side electrode formed on one surface of the solid electrolyte body;
a reference-gas-side electrode formed on the other surface of the solid electrolyte body;
a measuring-gas-side lead portion formed on the one surface of the solid electrolyte body in electrical connection with the measuring-gas-side electrode;
a reference-gas-side lead portion formed on the other surface of the solid electrolyte body in electrical connection with the reference-gas-side electrode;
a dense protective layer formed on the one surface of the solid electrolyte body so as to cover the measuring-gas-side lead portion; and
a porous protective layer laminated on the dense protective layer so as to cover the measuring-gas-side electrode;
wherein the measuring-gas-side lead portion includes a base end region, extending in an area away from a base end of the dense protective layer, and a base region covered with the base end of the dense protective layer; and
wherein the relationship is established as QB≧0.8 QA where QB represents a porosity rate of the base end region of the measuring-gas-side lead portion in an area spaced from the base end of the dense protective layer by a distance of approximately 0.5 mm and QB represents a porosity rate of the base region of the measuring-gas-side lead portion.

8. The gas sensor according to claim 7, wherein the gas sensing element further comprises:
first and second electrode terminals formed on the solid electrolyte body in electrical connection with the measuring-gas-side lead portion and the reference-gas-side lead portion, respectively.

9. The gas sensor according to claim 7, wherein the gas sensing element further comprises:
a bonding layer interposed between the porous protective layer and the measuring-gas-side electrode.

10. The gas sensor according to claim 7, wherein the gas sensing element further comprises:
a bonding layer interposed between the porous protective layer and the dense protective layer.

11. The gas sensor according to claim 7, wherein the gas sensing element further comprises:
a duct forming layer laminated on the other surface of the solid electrolyte body and having a duct formed in a face-to-face relationship with the reference-gas-side electrode.

12. The gas sensor according to claim 7, wherein:
the base end region of the measuring-gas-side lead portion is covered with a localized area of the dense protective layer in a position close proximity to the base end of the dense protective layer; and
wherein the dense protective layer has a smoothed surface in an area except for the localized area to allow the base end region and the base region of the measuring-gas-side lead portion to have given porosity rates, respectively.

13. A method of manufacturing a gas sensing element comprising the steps of:
preparing a primary laminate body upon forming a measuring-gas-side electrode and a measuring-gas-side lead portion on one surface of a solid electrolyte body in electrical connection with each other, forming a reference-gas-side electrode and a reference-gas-side lead portion on one surface of the solid electrolyte body in electrical connection with each other, and forming a dense protective layer on the one surface of the solid electrolyte body so as to cover the measuring-gas-side lead portion to form the primary laminate body;
smoothing the primary laminate body on both sides thereof upon pressing the same at a pressing position spaced from a base end of the dense protective layer by a distance greater than 0.5 mm;
laminating a porous protective layer on a surface of the dense protective layer of the primary laminate body so as to cover the measuring-gas-side electrode; and
laminating a duct forming layer, having a duct formed in face-to-face relationship with the reference-gas-side electrode, on the other surface of the solid electrolyte body to form a secondary laminate body; and
firing the secondary laminate body to form the gas sensing element.

14. The method of manufacturing the gas sensing element according to claim 13, wherein:
the measuring-gas-side lead portion includes a base end region, extending in an area away from a base end of the dense protective layer, and a base region covered with the base end of the dense protective layer; and
wherein the relationship is established as QB≧0.8 QA where QB represents a porosity rate of the base end region of the measuring-gas-side lead portion in an area spaced from the base end of the dense protective layer by a distance of approximately 0.5 mm and QB represents a porosity rate of the base region of the measuring-gas-side lead portion.
